(19) United States
(12) Patent Application Publication
(10) Pub. No.: US 2016/0121429 A1
(43) Pub. Date: May 5, 2016

(54) REPAIRING SUBSTRATES OF POLYCRYSTALLINE DIAMOND CUTTERS

(71) Applicant: ULTERRA DRILLING TECHNOLOGIES, L.P., Fort Worth, TX (US)

(72) Inventor: SATYA SAI GAJAPATHI, Edmonton (CA)

(21) Appl. No.: 14/927,242

(22) Filed: Oct. 29, 2015

Related U.S. Application Data
(60) Provisional application No. 62/072,393, filed on Oct. 29, 2014.

(51) Int. Cl. B23K 26/34; B23H 9/00; B23K 10/02; B23K 26/00; E21B 10/573; B23K 15/00

(52) U.S. Cl. CPC B23K 26/34; E21B 10/573; B23K 15/0086; B23K 15/0093; B23K 15/0006; B23K 10/027; B23K 26/0006; B23H 9/00; B23K 2203/18

(57) ABSTRACT

A method of repairing a wear or cutting element of a tool, the tool comprising a sintered polycrystalline diamond compact (PDC) structure bonded to a cemented metal carbide substrate, an example of which is a PDC cutter for an earth-boring drill. One example of the method comprises heating a spot within the damaged area of the substrate while introducing the inlay material to the spot, resulting in the substrate at the spot being heated and the inlay material melting onto the spot, without heating the substrate to the point of causing graphitization or rupture of diamond-to-diamond bonds of the diamond structure.

### BACKGROUND

To improve performance of cutting elements on earth boring tools, such as drill bits, one or more wear or working surfaces of the cutting elements are made from a layer of polycrystalline diamond (PCD) in the form of a polycrystalline diamond compact (PDC) that is attached to a substrate. This layer of PCD is often also called a “diamond table” or a “diamond crown.” A common substrate is cemented tungsten carbide. PDC, though very hard with high abrasion or wear resistance, tends to be relatively brittle. The substrate, while not as hard, is tougher than the PDC, and thus has higher impact resistance. Therefore, such a structure is more suitable for drilling and other downhole applications.

Cubic boron nitride (CBN) is, for many wear applications, a suitable substitute for PCD, and therefore references in this specification to polycrystalline diamond, or PCD, and polycrystalline diamond compacts, or PDC, are intended to refer also to CBN and compacts made from CBN and other such superhard materials unless specifically excluded.

PDC cutters and wear elements, particularly those used in downhole tools, will typically be attached to a cemented metal carbide substrate. Cemented metal carbide substrates are a composite formed by sintering under high temperature and pressure, or by microwaves, powdered metal carbide with a metal binder. This process results in a cemented carbide material that is much denser, and has a much higher percentage of, carbide as compared to composites of carbide and metal that are made using infiltration techniques. Substrates used for PDC cutters typically have a carbide (e.g. tungsten carbide) density of at least 75% by volume in some examples. In other examples, the carbide density is at least 80%, and still other examples of at least 90%. In comparison, matrix body drill bits made by packing a mold with metal carbide powder, and then infiltrating it with a metal alloy to cement the powder pack, typically have a carbide density of about 60% by volume, but it can be as high as 70% by volume.

Attaching of the sintered substrate to the PDC can be done in a number of ways, the most conventional of which is to pack diamond grit without a metal catalyst next to a substrate of cemented metal carbide, such as tungsten carbide, and then sintering.

During sintering metal binder in the substrate—cobalt or a cobalt alloy in the case of cobalt cemented tungsten carbide—sweeps into and infiltrates the diamond grit. The metal binder acts as the catalyst to sinter the grains of diamond while also cementing the resulting PDC to the substrate in a single step.

The composite of the PDC and the substrate can be fabricated in a number of different ways. It may also, for example, include transitional layers in which the metal carbide and diamond are mixed with other elements for improving bonding and reducing stress between the PDC and substrate. A reference to a substrate of metal carbide is intended, unless otherwise specifically stated, to include substrates with transitional layers.

FIG. 1 illustrates an example of a PDC drag bit. PDC drag bit 100 is intended to be a representative example of a downhole tool in general, and more specifically of earth boring tools, drill bits for drilling oil and gas wells, and PDC drag bits. The bit is intended to be rotated around its central axis 102, it is comprised of a bit body 104 connected to a shank 106 having a tapered threaded coupling 108 for connecting the bit to a drill string and a “bit breaker” surface 111 for cooperating with a wrench to tighten and loosen the coupling 108 to the drill string. The exterior surface of the body intended to face generally in the direction of boring is referred to as the face of the bit. The face generally lies in a plane perpendicular to the central axis 102 of the bit. The body is not limited to any particular material. It can be, for example, made of steel or a matrix material such as powdered tungsten carbide cemented by metal binder.

Disposed on the bit face are a plurality of raised “blades,” each designated 110, that rise from the face of the bit. Each blade extends generally in a radial direction, outwardly to the periphery of the cutting face. In this example, there are six blades substantially equally spaced around the central axis and each blade, in this embodiment, sweeps or curves backwardly in relation to the direction of rotation indicated by arrow 115.

On each blade is mounted a plurality of discrete cutting elements, or “cutters,” 112. Each discrete cutting element is disposed within a recess or pocket. In a drag bit the cutters are placed along the forward (in the direction of intended rotation) side of the blades, with their working surfaces facing generally in the forward direction for shearing the earth formation when the bit is rotated about its central axis. In this example, the cutters are arrayed along blades to form a structure cutting or gouging the formation and then pushing the resulting debris into the drilling fluid which exits the drill bit through the nozzles 117. The drilling fluid in turn transports the debris or cuttings uphole to the surface.

In this example of a drag bit, all of the cutters 112 are PDC cutters. However, in other embodiments, not all of the cutters need to be PDC cutters. The PDC cutters in this example have a working surface made primarily of super hard, polycrystalline diamond, or the like, supported by a substrate that forms a mounting stud for placement in a pocket formed in the blade. Each of the PDC cutters is fabricated discretely and then mounted—by brazing, press fitting, or otherwise—into pockets formed in bit. However, the PDC layer and substrate are typically used in the cylindrical form in which they are made. This example of a drill bit includes gauge pads 114. In some applications, the gauge pads of drill bits such as bit 100 can include an insert of thermally stable polycrystalline diamond (TSP).

FIGS. 2A-2C illustrate a representative example of a PDC cutter suitable for drill bit, such as the PDC bit of FIG. 1. Representative cutter 200 is comprised of a substrate 202, to which is attached a layer of sintered polycrystalline diamond (PCD) 204. This layer is sometimes also called a diamond table. Cutter 200 is not drawn to scale. It is intended to be representative of cutters generally that have a polycrystalline diamond structure attached to a substrate, and in particular the one or more of the PDC cutters 112 on the drill bit 100 of FIG. 1. In this example, an edge between top surface 206 and side surface 208 of the layer of PCD 204 is beveled to form a beveled edge 210. The top surface and the beveled surface are, in this example, each a working surface for contacting and cutting through formation. A portion of the side surface, particularly nearer the top surface 206, may also contact the formation or debris.

Although frequently cylindrical in shape, PDC cutters are not limited to a particular shape, size, or geometry, or to a single layer of PCD. Not all of the cutters on a bit must be of the same size, configuration, or shape. In addition to being sintered with different sizes and shapes, PDC cutters can be cut, ground, or milled to change their shapes. Furthermore, a cutter could be formed of multiple discrete PCD structures. Other examples of possible cutter shapes include pre-flatted gauge cutters, pointed or scribe cutters, chisel-shaped cutters, and dome inserts.

PDC bits are typically used multiple times. However, the cutters on the bits are sometimes damaged. Before such bit can be used again, the damaged cutters need to be replaced. Sometimes the PCD layer on the cutter has chipped or cracked. Sometimes the substrate of the cutter is damaged or excessively worn. Pitting, erosion, abrasion, chipping and gouging are typically the types of damage suffered by substrates of cutters.

FIGS. 3A-3C illustrate examples of three types of damage. In FIG. 3A cutter 300 has a diamond layer 301 attached to a substrate 302. The diamond layer is not damaged, but the outer surface of the substrate 302, which was smooth when fabricated, shows pitting over its entire surface. Cutter 304 of FIG. 3B also shows no sign of damage to the diamond table 306. However, area 308 of the surface of the substrate 310 has been damaged by erosion. FIG. 3C illustrates a PDC cutter 312 with a diamond layer 314 attached to a substrate 316. In this example the substrate has been abraded by a rubbing action that formed a damaged area in the form of groove 318.

### SUMMARY

The invention relates to processes, examples of which are described below, for cladding a surface of a cutting or wear element, the element comprising a layer of diamond material bonded to a substrate comprised of a cemented metal carbide, and to elements made from such a process. The processes may be used as part of a method for repairing damage to the substrate caused by use of the cutting or wear element. The processes avoid overheating the layer of diamond. Overheating the layer of diamond would risk graphitizing the diamond and thermal stress cracking caused by dissimilar expansion of metal catalyst present in the diamond layer. After repair, the cutting or wear element may be attached to the tool by brazing.

One representative example of these processes involves the use of a high power density energy source to heat a comparatively small area or spot on the surface of the substrate of a cutting or wear element bonded to a diamond wear layer, causing that region to heat while also causing a material introduced to the spot to melt and bond to the substrate. The high power density energy source is controlled in a manner that melts the material so that it is deposited on the surface of the substrate at the spot being heated, without heating the substrate to the point of causing the diamond wear layer to be overheated or the substrate to crack. In one embodiment of the method the inlay material has a melting point higher than the brazing material with which the substrate of the cutter is subsequently attached to a body of a drill bit.

In one aspect of the invention, a method for repairing a downhole cutter with a substrate and diamond table comprises heating an inlay material with a high intensity beam and introducing the heated inlay material onto a damaged portion of the substrate such that the inlay material is bonded to the damaged portion of the substrate. The method can include heating the damaged portion of the substrate with the high intensity beam prior to introducing the heated inlay material. The method can include preheating the substrate prior to heating the damaged portion with the high intensity beam.

In another aspect of the invention, a cutter removed from a downhole drill bit comprises a hard table supported by a substrate. The cutter includes a first carbide portion and a second inlaid portion of an inlay material deposited by introducing the material to a high intensity energy beam applied to the substrate.

In another aspect of the invention, a downhole drill bit with cutters mounted to the bit comprises a cutter with a substrate including a carbide portion and a deposited portion. The deposited portion is an inlay material introduced to the carbide portion with a high intensity energy beam to heat the inlay material and deposit it on the substrate.

### BRIEF DESCRIPTION OF THE DRAWINGS

FIG. 1 is a perspective view of a PDC drag bit.

FIGS. 2A, 2B and 2C are perspective, side and top views, respectively, of a representative PDC cutter suitable for the drag bit of FIG. 1.

FIGS. 3A, 3B and 3C are each an example a PDC cutter having a least portion of the surface area of its substrate damaged through use.

FIG. 4 is a flow diagram of a process for repairing a substrate of a PDC cutter.

FIG. 5 is a perspective rendering of a laser welder being used to repair a substrate of a PDC cutter.

FIG. 6A is a representative example of a PDC cutter with a surface partially damaged by erosion.

FIG. 6B shows the PDC cutter of FIG. 6A after the damaged area in its surface area has been filled using the process of FIG. 4.

FIG. 6C is a bottom view of the FIG. 6B.

FIG. 6D is a cross-section of the PDC cutter of FIG. 6B taken along section line 6D-6D.

FIG. 6E is a cross section of the PDC cutter, taken along the same section line 6D-6D, after excess filling material within the damaged area has been removed.

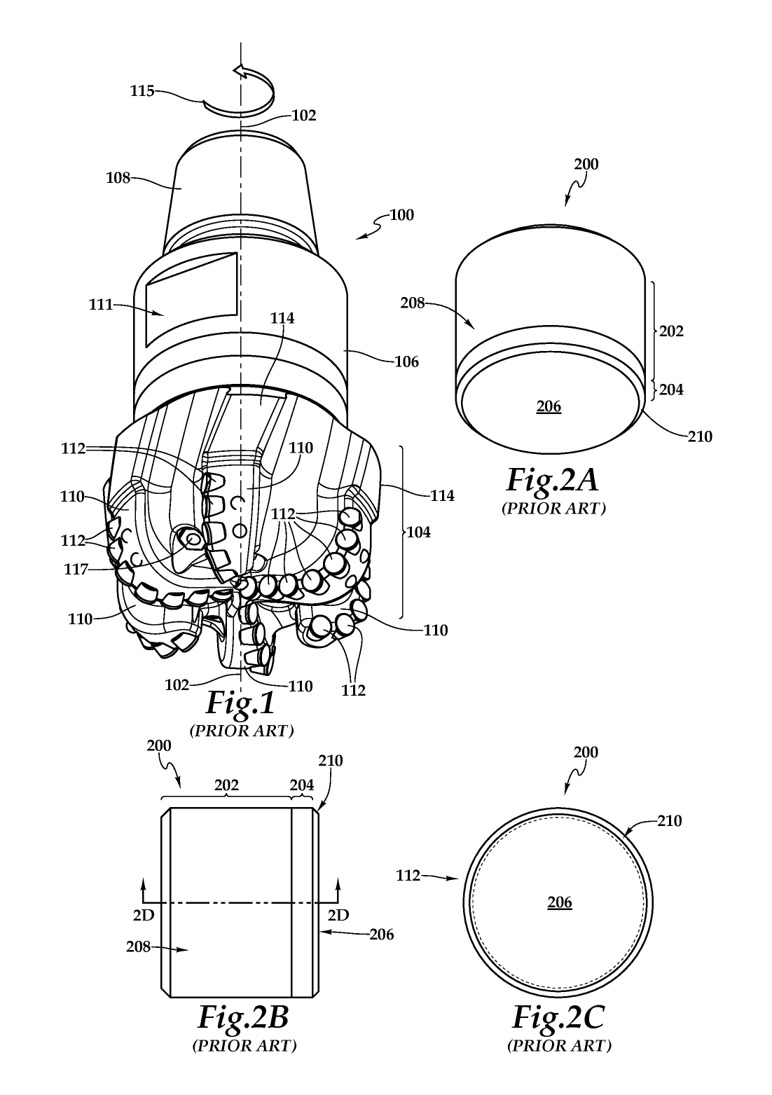

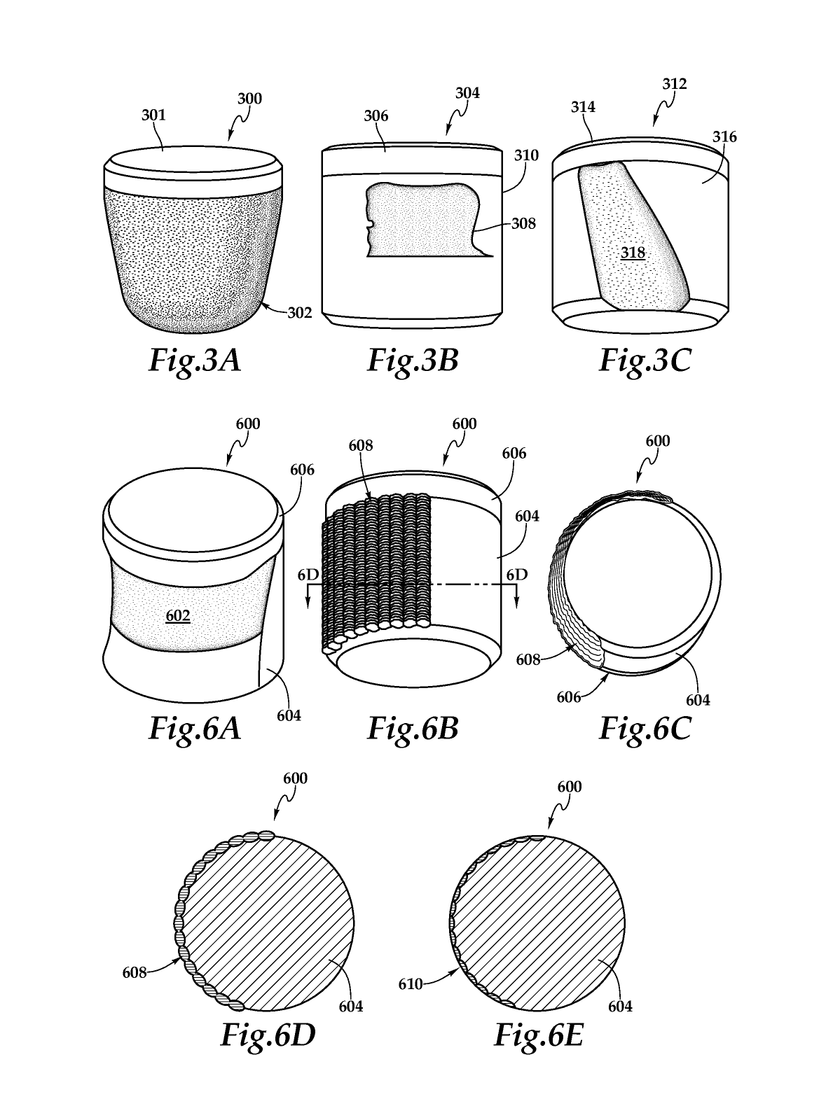

### DETAILED DESCRIPTION OF THE INVENTION

In the following description, like numbers refer to like elements.

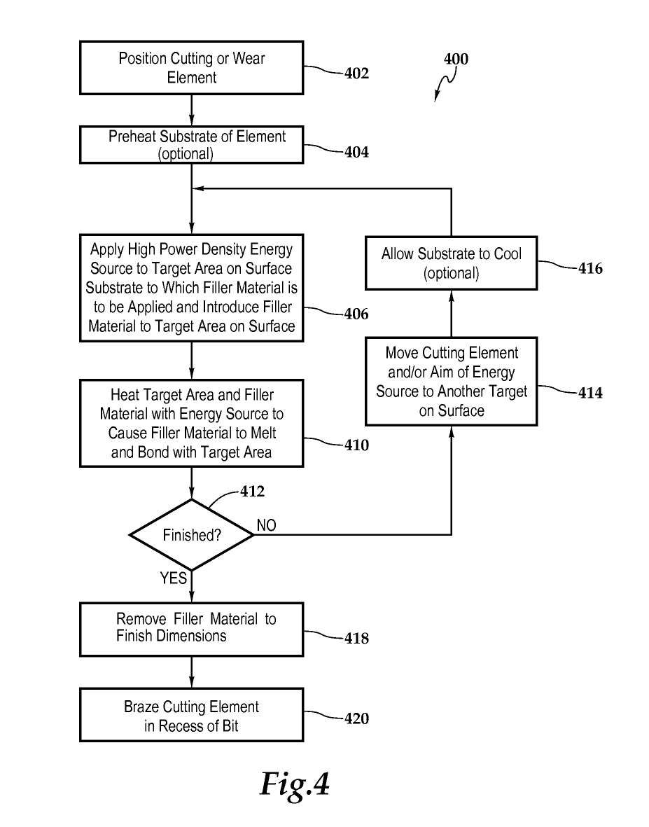

The method illustrated by FIG. 4 is an exemplary embodiment of a method for restoring the geometry of a worn or damaged substrate of a PDC cutter using an inlay material and localized heating of a portion of the surface of the substrate to which the inlay material is being applied. The density of carbide (e.g. tungsten carbide) in the substrate subjected to the method is least 75% by volume in one example, 80% by volume in another example, and at least 90% by volume in another example. The inlay material is comprised of, for example, a metal alloy or particle-matrix composite. In one example, the metal alloy is one or more alloys selected from a group comprising cobalt based alloys, nickel based alloys, copper based alloys, and silver based alloys. Examples of hard particles for a particle-matrix composite include one or more chosen from the group consisting of diamond, boron carbide, boron nitride, aluminum nitride, and carbide and borides of the group consisting of W, Ti, Mo, V, Nb, Zr, and Cr. Examples of matrix material for combining with any one or more of the foregoing particles to form the particle-matrix composite include the metal alloys identified above. The foregoing examples are intended to be non-limiting examples.

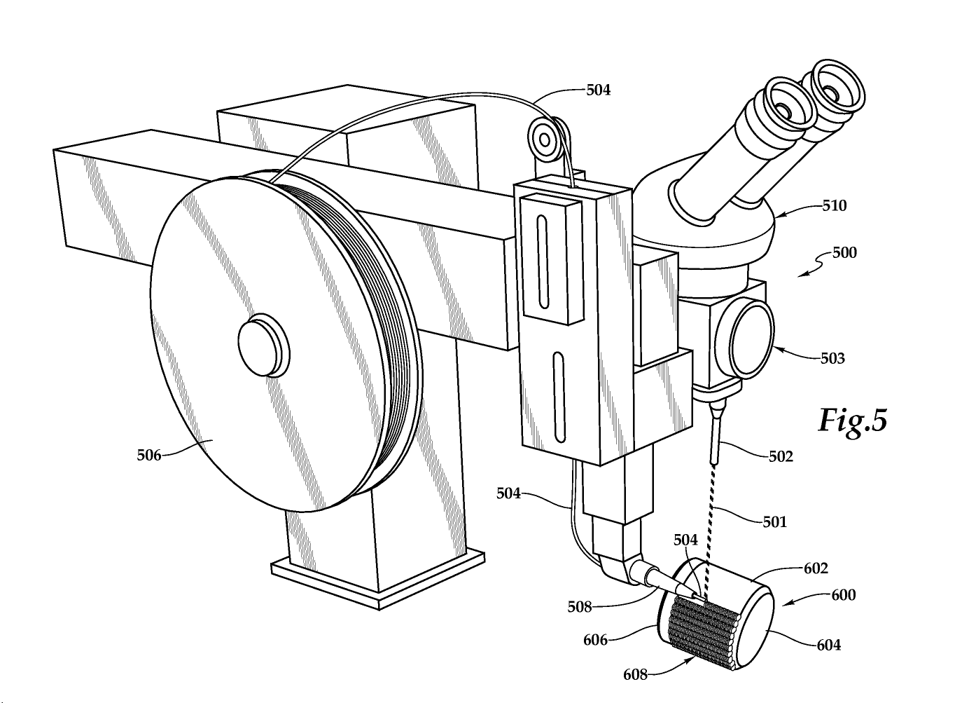

The illustrated embodiment of FIG. 4 will be described in reference to FIG. 5, which includes a high intensity energy source such as an electron beam, a laser beam or other source capable of applying high-intensity energy to a limited area on the surface of a substrate. The illustrated embodiment will also be described in reference to FIGS. 6A-6E. These figures illustrate a representative, non-limiting example of a wear or cutting element in the form of finished PDC cutter 600 that had been previously brazed into a pocket in a PDC bit and, after having been damaged during drilling of a bore hole through an earth formation, has been removed from the bit. The PDC cutter has a damaged area 602 on the surface of its cemented metal (tungsten) carbide substrate 604. A diamond layer 606, comprised of sintered polycrystalline diamond, is attached to the substrate 604. Although the diamond layer 606 of the PDC cutter 600 is not damaged in this example, the methods described herein may also be used to reclaim PDC cutters that include partially damaged diamond layers. Such cutters, when reinstalled on a bit after the geometry of the substrate is restored, can be rotated to expose an undamaged edge of the diamond layer as the new cutting surface.

A method 400 for depositing an inlay material is illustrated in FIG. 4. At step 402 a cutter is positioned for processing. The substrate of cutter 600 can be preheated at step 404. Preheating the cutter is optional. Preheating the cutter can promote adhesion of inlay material to the substrate during processing. The preheat temperature in a preferred embodiment is less than about 750° C., the temperature where diamond begins to degrade. At step 406 a high-intensity energy is applied to a relatively small area of an outer surface of a cutting or wear element having a cemented metal carbide substrate and a diamond layer, such as PDC cutter 600. In the illustrated embodiment of the method a laser beam 501 emitted by tip 502 applies the high-intensity energy. A laser (not visible) located within the structure 503 of laser welder 500 generates the laser beam.

A high power density energy is applied to a relatively small spot area on the surface of the PDC substrate. This spot, which will be referred to as the target area, has an area that is much smaller than the total surface area of the exterior of the substrate. An inlay material is introduced to the target area, so that it will be melted by heat generated from application of the high power density energy source that is being applied to the target area. In a preferred embodiment, the inlay material is introduced into the high energy beam. Alternatively, the inlay material is positioned on the substrate prior to application of the high energy beam and is melted by the high energy beam. Alternatively, the high energy beam is applied to the substrate to heat a portion of the substrate and the inlay material is applied to the portion of the substrate heated to a temperature above the melting temperature of the inlay material.

In one embodiment the spot area is less than one square millimeter. In an alternative embodiment the spot area is less than four square millimeters. Other spot sizes are possible. In some embodiments a heat sink can be placed in contact with the cutter to dissipate heat and limit the temperature of the cutter during processing.

An inlay material in the form of wire 504 is placed in the path of the laser 501 above the target area of the substrate 602 or in contact with the substrate. At step 410, the target area is heated and the inlay material is melted onto the target area. The inlay material then bonds to the heated target area. In a preferred embodiment the inlay material is introduced to the substrate simultaneously with the energy source. The inlay material may be in the form of a wire, rod, ribbon, powder or other form.

The laser welder may include a guide 508 for positioning the wire. A laser welder may also include a microscope 510, which is aligned with the laser, for assisting an operator with aligning the laser with the target area on the substrate 602, and with introducing a tip of the wire between laser beam 501 and the target area.

In some embodiments, the inlay material forms an electrode. The electrode is introduced to the target area and, when power is supplied to the electrode, the inlay material is melted and accelerated toward the substrate. For example, with a nano-fusion heating and cladding technique at step 406, an electrode that creates the spark constitutes the inlay material, and thus the inlay material is introduced by placing the electrode adjacent the target area on the surface of the substrate.

Unless application of inlay material is finished, as indicated by decision step 412, the process continues to a new target area adjacent the old target area. At step 414 substrate is moved (translated and/or rotated), or the energy source (laser tip 502 in the example) is shifted, or both, before steps 408-410 are repeated to heat a new target area adjacent the old target area and to melt the inlay material onto the new target area so that it will bond with both the new target area and the inlay material applied to the old target area. The process may be run in a continuous fashion, with the energy source remaining turned on as the substrate and/or energy source are moved. The inlay material may also be supplied continuously. In the example of a technique using a sacrificial electrode, such as electro-spark discharge (ESD), the electrode can be rotated so that it does not stick to the target area. Alternatively, the energy source can be run in a pulsed mode to supply energy to the substrate intermittently.

In the example of the laser welder 500, using a wire form for the inlay material allows feeding it continuously from reel 506, through tip 502, as it is being melted, thus enabling a quick resupply of the inlay material for applying to an adjacent target region on the surface of the substrate. Thus, inlay can be more quickly deposited over an area on the surface of the substrate while maintaining a relatively small heated target area. This example of inlay material supply arrangement also permits the laser welder to function in a continuous manner. Alternatively, the inlay material may be supplied intermittently. Alternatively, two or more different inlay materials may be supplied simultaneously, intermittently or alternately.

Optionally, as indicated by step 416, the energy source can be turned off or the energy reduced to allow cooling, before steps 406-410 are repeated. Once application of the inlay material is finished or completed at decision step 412, the exterior surface of the inlay material can be machined (with, for example, a grinder) to form a smooth surface at step 418. It this example, the inlay material is ground to restore the PDC cutter to its original geometry, before being damaged, so that it can be brazed into the pocket of a bit body at step 420. In this example of a repaired PDC cutter, it is preferably brazed so that the damaged area (or as much of it as possible) is oriented to face the inside of the pocket into which it is being brazed. However, if the inlay material includes a high wear resistance material, such as carbides, the pocket need not hide the whole of the repaired surface. At step 420 the repaired PDC cutter is attached to the body of the bit. In a preferred embodiment, the inlay material has a melting point temperature higher than the melting point temperature of the braze material used to attached the repaired substrate of the PDC cutter to a pocket on a drill bit.

In the example of the PDC cutter 600 with a damaged substrate shown in FIG. 6A-6E, the damaged area 602 shown in FIG. 6A, which is an illustration of the PDC cutter before being repaired, is shown in FIGS. 6B-6D, which illustrate the PDC cutter after repair using the method of FIG. 4, as having been filled by rows 608 of inlay material. Each row is comprised of a line of adjoining beads of inlay material deposited according to steps 406-410 of FIG. 4. The relative position of the PDC cutter and laser are translated at step 414 of the method of FIG. 4 to create a row of inlay material beads. The relative position of the substrate and laser is rotated and translated at step 414 to create a new row of inlay material beads adjoining the previous one. This may require the inlay material in the adjacent line that is immediately adjacent to the heated area to be partially melted to ensure bonding of the new inlay material being deposited. This process is repeated until the desired amount of inlay material is applied. In this example, it is repeated until the entire damaged area 602 is filled, as shown in FIGS. 6B-6D. Once the damaged area is filled, excess filling material is ground off to leave the filling material with a smooth surface 610 that is flush with the undamaged portions of the surface of the substrate, as shown by FIG. 6E.

In one embodiment the target area of the surface of the substrate of the wear or cutting element is heated to the point of melting the inlay material and bonding it to the target area, but is not heated to the point of causing the metal binder (cobalt or a cobalt alloy, typically) or the metal carbide, which is typically tungsten carbide, in the substrate to melt. In another embodiment, some of the metal binder on the surface is melted without the metal carbide melting or the metal binder and the inlay material becoming inter-diffused. In yet another embodiment, the heating is sufficient and occurs for long enough to allow for some inter-diffusion of the metal binder and the inlay material. Excessive heating of a portion of the substrate may lead to a temperature differential in the cutter which can generate internal stress that leads to cracks forming within the substrate. Temperature differential and internal stress can be minimized by preheating the cutter before applying inlay material into the cutter. Alternatively, or in addition, a heat sink in contact with the cutter can limit the temperature change of the cutter and limit temperature differential.

In addition to a laser beam, as described above in connection with the laser welder of FIG. 5, a different high power density energy source for heating a target area on the surface of a wear or cutting element may be used such as other types of optical beam or an electron beam. In an electron beam, electrons are emitted from a source filament—for example, one made of tungsten or lanthanum boride—that is heated by an applied voltage to as much as 3000° K to overcome the work function and emit electrons. The emitted electrons can then be accelerated and focused by a magnetic lens toward the substrate.

Alternatives to laser or electron beam cladding include micro-plasma transferred arc (micro PTA) and electro spark discharge cladding. Micro PTA generates a plasma in a shield gas by a discharge to the substrate. A coating material is injected into the plasma to melt in the molten pool generated by the plasma at the surface of the substrate. Electro spark discharge (ESD) surfacing or cladding, in contrast to the other techniques described above, uses a sacrificial electrode as the source of the cladding material. The electrode is held close to the surface of the substrate and an electric discharge between the electrode and the substrate melts the substrate and the cladding material of the electrode.

The melted cladding material is accelerated toward the substrate where it solidifies and bonds with the surface. The electrode is rotated so that it doesn't stick to the welded area. In one example of using ESD to generate heat for the methods described herein, electric sparks are generated at the rate of 500 to 600 pulses per second releasing 0.5 to 1 joules of energy per pulse.

Step 406 involves heating a small volume of the target, compared to the relative size of the substrate element, almost adiabatically to bond with the inlay material. Such adiabatic heating can be achieved by using high power density energy sources and faster travel speeds. In one embodiment, the power density of the energy source is of the order of 10⁸ W/m² or higher to achieve the localized heating. However, despite this high power density, localized heating of a small volume leads to minimal impact on the material's previous thermal history, as the total heat input remains relatively low. As a result, thermal stress on the cutter can be minimized to reduce the risk of cracking of the substrate element. The layer of polycrystalline diamond is also protected from overheating which could lead to thermal degradation. Thermal degradation of the diamond layer in the form graphitization or rupturing of diamond to diamond bonds due to expansion of metal catalyst within the polycrystalline diamond layer generally starts to occur at a temperature of about 750° C.

The rate of deposition can control the density of the cladding. The density of the cladding can range from a material with high porosity to a dense material that is fully consolidated. A highly porous inlay material may, for example, be infiltrated with brazing material when the cutter is mounted to the bit.

Some cladding techniques mentioned above for use in the exemplary process of FIG. 4 use a shielding gas. The shielding gas may be a noble gas used to exclude reactive gases such as oxygen or nitrogen from the molten weld pool to limit reactions with the metal. Shield gases may include argon or helium. The shield gas can also accelerate cooling of the work area and carry off excess heat, further limiting the temperature rise of the substrate during processing.

In alternative embodiments, combinations of processes can also be used, for example, to obtain specific material properties or improve the processing speeds. In one example, electro-static discharge is used to deposit a material on the substrate and a laser is then used to heat the deposited material to anneal or consolidate the deposit. In another example, a laser is used to deposit inlay material on top of an electro-static discharge deposited layer to increase the processing speeds.

In still other embodiments of the basic process represented in FIG. 4, multiple layers of cladding can be applied to produce a deposit up to 5 mm thick. Furthermore, each of these layers need not be comprised of the same inlay material. Multiple layers, each made a different inlay material, may be deposited. For example, a first material such as tungsten carbide may be deposited in a first layer, and a second layer may be a different material such as bronze. The second layer may also infiltrate the first layer to increase the density or bind particles together more completely. Due to the relatively small size of the target area, patterns of different materials can be applied to the substrate adjacent or on top of each other. A line of titanium carbide can be deposited on the substrate and adjacent to that or on top of it a line of bronze can be deposited. The adjacent materials may interact to form an alloy or an amalgam with different material properties.

In one example, the inlay material has a melting point greater than 750° C. In an alternative embodiment the inlay material has a melting point at or above 1000° C. Despite the inlay material having a melting point above 750° C. in one example, or above 1000° C. in another example, the method of FIG. 4 can be used to bond the inlay material to the substrate of a wear or cutting elements without enough energy into the substrate to heat the diamond layer(s) on the wear or cutting element to the point of causing graphitization or rupturing the diamond to diamond bonds. In one embodiment, an inlay material suitable for use with a laser welding technique at step 406 is silicon bronze with a melting temperature of at least 1000° C.

Alternatively, the inlay material at step 406 is an alloy that contains copper and nickel. In a preferred embodiment the inlay material includes approximately 70% copper and approximately 30% nickel by weight. Other ratios of copper and nickel and copper alloys can be used as an inlay. In an alternative embodiment the nickel content of the copper alloy is in the range of 10% to 40% by weight. Copper nickel has advantageous corrosion resistance to salt and other harsh environments. Additional elements can be included in amounts less than 2% such as lead, iron, manganese, cobalt, silver and zinc. This alloy is especially suitable for use as a consumable electrode, which comprises the inlay material, when using an electrostatic discharge generator at step 406 to heat the substrate.

The foregoing description is of exemplary and preferred embodiments. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated or described structures or embodiments.

What is claimed is:

1. A method for repairing a downhole cutter with a substrate and diamond table comprising:
heating an inlay material with a high intensity beam; and
introducing the heated inlay material onto a damaged portion of the substrate such that the inlay material is bonded to the damaged portion of the substrate.

2. The method of claim 1 including heating the damaged portion of the substrate with the high intensity beam prior to introducing the heated inlay material.

3. The method of claim 2 including preheating the substrate prior to heating the damaged portion with the high intensity beam.

4. The method of claim 1 wherein the inlay material is in the form of a wire fed to the high intensity energy beam at the heated damaged portion.

5. The method of claim 1 wherein the inlay material is powder fed to the high intensity energy beam at the heated damaged portion.

6. The method of the claim 1, wherein the high intensity energy beam is a pulsed laser beam.

7. The method of claim 1, wherein a source for the high intensity energy comprises an electro spark discharge generator and the inlay material comprises an electrode of the generator.

8. The method of claim 1 wherein the inlay material is comprised of approximately 70% copper and approximately 30% nickel by weight.

9. The method of claim 1 wherein the inlay material has a melting temperature of greater than 750 degrees Celsius.

10. The method of claim 1 wherein the inlay material has a melting temperature of at least approximately 1000 degrees Celsius.

11. The method of claim 1 wherein the inlay material is a copper based alloy.

12. The method of claim 11 wherein the copper based inlay material is comprised of silicon bronze.

13. The method of claim 1 wherein the metal carbide in the substrate has a density of at least 75% by volume.

14. The method of claim 1 where the high intensity energy beam impinges on an area of the substrate less than 4 square millimeters of the substrate.

15. The method of claim 1 including introducing a second layer of the heated inlay material over the inlay material introduced onto the damaged portion of the substrate.

16. The method of claim 1 including heating a second inlay material and introducing the second inlay material over the inlay material introduced onto the damaged portion of the substrate.

17. The method of claim 1 including heating a second inlay material and introducing the second inlay material adjacent the inlay material introduced onto the damaged portion of the substrate.

18. The method of claim 1 wherein the high intensity energy beam is selected from the group of laser beam, electrostatic discharge, electron beam, plasma arc and micro-plasma transferred arc.

19. The method of claim 1 wherein the inlay material includes carbide particles.

20. A cutter removed from a downhole drill bit comprising:
a hard table supported by a substrate including:
a first carbide portion; and
a second inlaid portion of an inlay material deposited by introducing the material to a high intensity energy beam applied to the substrate.

21. The cutter of claim 20, wherein the inlay material is melted by the high intensity energy beam and solidifies on the substrate.

22. The cutter of claim 20, wherein the high intensity energy beam is a laser beam.

23. The cutter of claim 20, wherein the high intensity energy beam is generated by a source selected from the group of electrostatic discharge generator, electron beam generator, plasma arc generator and micro-plasma transferred arc generator.

24. The cutter of claim 20, wherein the inlay portion comprises a first material and a second material adjacent the first material.

25. The cutter of claim 20, wherein the inlay material includes copper and nickel.

26. A downhole drill bit with cutters mounted to the bit comprising:
a cutter with a substrate including a carbide portion and a deposited portion;
wherein the deposited portion is an inlay material introduced to the carbide portion with a high intensity energy beam to heat the inlay material and deposit it on the substrate.

27. The downhole drill bit of claim 26 where the deposited portion is a copper alloy.

28. The downhole drill bit of claim 26 where the high intensity energy beam is a laser beam.

29. The downhole drill bit of claim 26 wherein the high intensity energy beam source is an electro spark discharge generator and the inlay material is introduced as an electrode of the generator.
